(19) United States
(12) Patent Application Publication
(10) Pub. No.: US 2005/0163321 A1
(43) Pub. Date: Jul. 28, 2005

(54) Circuit for processing audio signals

(75) Inventor: Takeyoshi Meguro, Nitta-gun (JP)

Correspondence Address: OLIFF & BERRIDGE, PLC, P.O. BOX 19928, ALEXANDRIA, VA, 22320, US

(73) Assignee: SANYO ELECTRIC CO., LTD., Moriguchi-shi (JP)

(21) Appl. No.: 11/008,608

(22) Filed: Dec. 10, 2004

(30) Foreign Application Priority Data
Jan. 22, 2004 (JP) 2004-014361

(51) Int. Cl. H04H 5/00

(52) U.S. Cl. 381/2; 381/16

(57) ABSTRACT

An audio signal processing circuit for demodulating an audio multiplexed signal and outputting the demodulated signal extracts a second audio signal from the audio multiplexed signal, has plural amplifying units for amplifying the second audio signal with different gains, respectively, and selects one of the plural amplifying units, and the selected amplifying units selectively outputs an amplified audio signal.

### CROSS-REFERENCE TO RELATED APPLICATIONS

The priority application Number JP 2004-014361 upon which this patent application is based is hereby incorporated by reference.

### BACKGROUND OF THE INVENTION

This invention relates to an audio signal processing circuit for processing audio multiplexed signals used for television broadcast.

As one of audio multiplexing systems used for television broadcast, there is an audio multiplexing system (hereinafter referred to as BTSC(Broadcast Television System Committee) audio multiplexing system) defined by BTSC of the United States in 1983. This system employs modulation frequency distribution including a monaural signal (combined signal L+R of left and right channels), a stereo signal (differential signal L−R of left and right channels), and a SAP (second audio program) signal, which is a second audio signal, as shown in FIG. 4.

Conventionally, as a circuit for demodulating and reproducing each signal of audio signals modulated by this BTSC audio multiplexing system, an audio signal processing circuit shown in FIG. 5 has been used. This conventional audio signal processing circuit is usually packaged as an integrated circuit. The audio signal processing circuit shown in FIG. 5 includes a signal extracting unit 31 for extracting a monaural signal, a stereo signal and a SAP signal from an audio signal according to the BTSC system, a first amplifier 32, a second amplifier 33, a switch 34, a expansion processing unit 35, and an processing unit 36.

The first amplifier 32 amplifies the stereo signal and outputs the amplified stereo signal. The second amplifier 33 amplifies the SAP signal at a predetermined amplification factor. The switch 34 selectively outputs one of the signal outputted from the first amplifier 32 and the signal outputted from the second amplifier 33. The expansion processing unit 35 performs the known dbx expansion processing (dbx decoding processing) on the signal outputted from the switch 34. The processing unit 36 receives input of the monaural signal and the signal outputted from the expansion processing unit 35. When the switch 34 has selected the signal outputted from the first amplifier 32, this processing unit 36 generates a result of mix (left channel signal) of the stereo signal (L−R signal) and the monaural signal (L+R signal) . It also generates a differential signal (right channel signal) of the stereo signal and the monaural signal. The processing unit 36 then outputs these left channel signal and right channel signal.

However, in some cases, a part of the signals constituting the audio multiplexed signal may have a frequency characteristic that is not flat. For example, the SAP signal has a frequency characteristic as shown in FIG. 6A. As such, the output level of the SAP signal cannot be coincident with the output level of the monaural signal and the stereo signal (level indicated by a broken line in FIG. 6A) over the entire frequency region. Therefore, currently, the amplification factor of the SAP signal with respect to the stereo signal differs from designer to designer, depending on the preference of the designer of the television apparatus, as shown in FIG. 6A (where the levels are close to each other on average) and FIG. 6B (where the levels are coincident in a low frequency region).

Thus, essentially, it is preferred that the amplification factor of the SAP signal is variable. However, to allow a variable amplification factor, the structure of the integrated circuit must be complicated.

### SUMMARY OF THE INVENTION

In view of the foregoing status of the art, it is one of objects of this invention to provide an audio signal processing circuit capable of performing variable control of the amplification factor of an audio signal included in an audio multiplexed signal, with a simple structure.

Thus, according to this invention, an audio signal processing circuit for demodulating an audio multiplexed signal and outputting the demodulated signal includes: an extracting circuit for extracting a second audio signal from the audio multiplexed signal; plural amplifying circuits for amplifying the second audio signal with different gains, respectively; and a selecting circuit for selecting one of the plural amplifying circuits and selectively outputting an amplified audio signal outputted from the selected amplifying circuit.

### BRIEF DESCRIPTION OF THE DRAWINGS

FIG. 1 is a structural block diagram showing an example of audio signal processing circuit according to an embodiment of this invention.

FIG. 2 is a structural block diagram showing another example of audio signal processing circuit according to the embodiment of this invention.

FIG. 3A is a schematic circuit diagram showing an exemplary structure of a switch unit.

FIG. 3B is a schematic circuit diagram showing another exemplary structure of the switch unit.

FIG. 4 is an explanatory view showing an example of BTSC audio multiplexed signal.

FIG. 5 is a structural block diagram showing an example of conventional audio signal processing circuit.

FIG. 6A is an explanatory view showing an exemplary setting to realize a level of a second audio signal that is close to stereo and monaural signals on average.

FIG. 6B is an explanatory view showing an exemplary setting to realize a level of a second audio signal that is coincident with stereo and monaural signals in a low frequency region.

### DESCRIPTION OF THE PREFERRED EMBODIMENTS

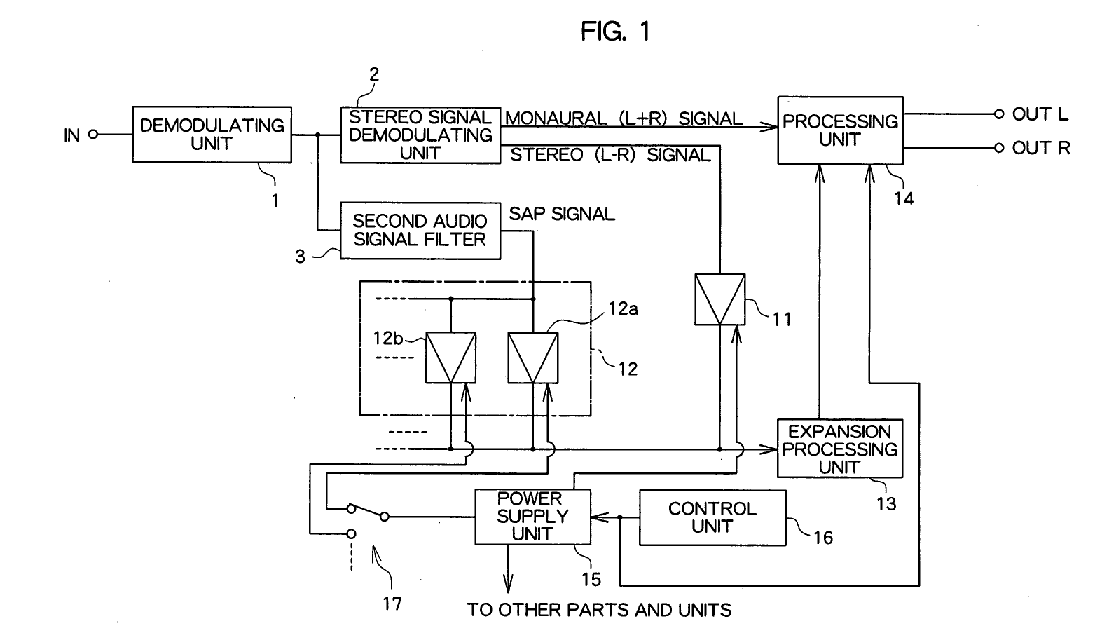

An embodiment of this invention will now be described with reference to the drawings. An audio signal processing circuit according to the embodiment of this invention is packaged as an integrated circuit. The audio signal processing circuit according to the embodiment of this invention includes a demodulating unit 1, a stereo signal demodulating unit 2, a second audio signal filter 3, a first amplifier 11, a second amplifier group 12, an expansion processing unit 13, an processing unit 14, a power supply unit 15, a control unit 16, and a switch 17, as shown in FIG. 1. In the following description, an audio multiplexed signal is assumed to be a BTSC audio multiplexed signal.

The demodulating unit 1 demodulates an audio multiplexed signal from a signal inputted through an input terminal IN and outputs the demodulated signal. The stereo signal demodulating unit 2 receives input of the audio multiplexed signal from the demodulating unit 1, and demodulates a stereo signal and outputs the demodulated stereo signal. Here, the stereo signal is a differential signal of left and right channels, that is, L−R. The stereo signal demodulating unit 2 also extracts a monaural signal from the audio multiplexed signal outputted from the demodulating unit 1 and outputs the extracted monaural signal. Here, the monaural signal is a combined signal of left and right channels, that is, L+R. The second audio signal filter 3 demodulates a second audio signal (SAP) from the audio multiplexed signal outputted from the demodulating unit 1 and outputs the demodulated second audio signal. These demodulating unit 1, stereo signal demodulating unit 2 and second audio signal filter 3 are for realizing functions similar to the conventional signal extracting unit 31.

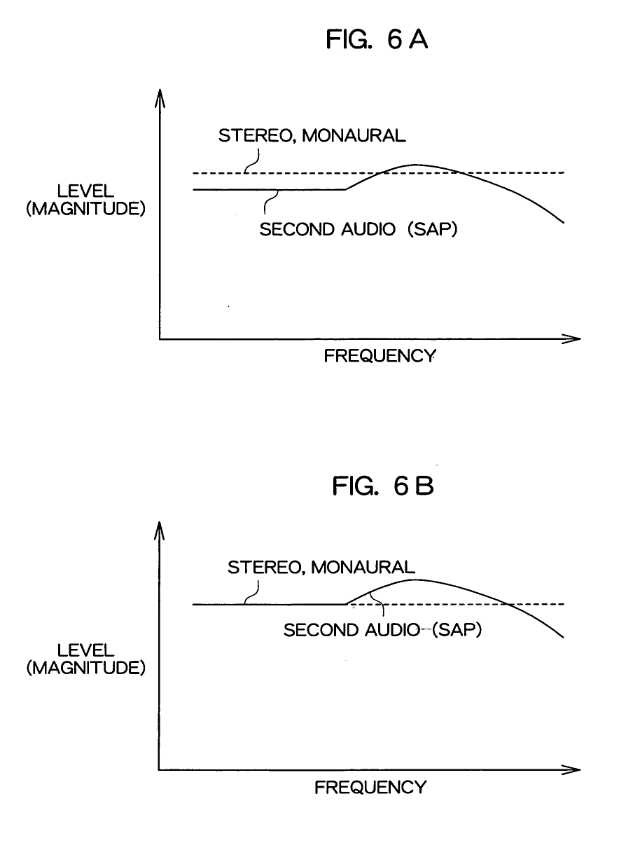

The first amplifier 11, when supplied with power, amplifies the stereo signal (L−R) at a predetermined amplification factor and outputs the amplified signal. The second amplifier group 12 includes plural second amplifiers 12a, 12b, . . . set to have different amplification factors from each other. Each of these second amplifiers 12a, 12b, . . . receives input of the second audio signal, and suppose that when each of these second amplifiers is supplied with power, they amplify the second audio signal at different amplification factors from each other and outputs the amplified signals. For example, the second amplifier 12a may have an amplification factor (gain) in the case where the second audio signal is made close to the stereo signal and the monaural signal on average as shown in FIG. 6A, while the second amplifier 12b may have an amplification factor in the case where the level of the stereo and monaural signals and the level of the second audio signal are made coincident in a low frequency region. This second amplifier group 12 is equivalent to the amplifying circuit of this invention. The expansion processing unit 13 is for expanding the signals outputted from the first amplifier 11 and the second amplifiers 12a, 12b, . . . if dbx processing has been performed on these signals, and then outputting the expanded signals. The expansion processing unit 13 is for realizing functions similar to the conventional expansion processing unit 35.

The processing unit 14 generates an audio signal to be outputted from the left channel and an audio signal to be outputted from the right channel on the basis of the monaural signal (L+R) and the signals outputted from the expansion processing unit 13, and outputs each of the audio signals to a corresponding output terminal OUTL or OUTR. The specific contents of the processing by this processing unit 14 will be described later in detail.

The power supply unit 15 selectively supplies power to one of the first amplifier 11 and the switch 17 in accordance with a control signal inputted from the control unit 16. This power supply unit 15 also supplies power to the other parts and units. The control unit 16 selects either the first amplifier 11 or the switch 17 in accordance with a selection signal inputted from an external control terminal (not shown) and outputs to the power supply unit 15 a signal (control signal) instructing supply of power to the selected amplifier or switch. This control unit 16 also outputs the control signal to the processing unit 14.

The switch 17 selectively supplies power supplied from the power supply unit 15, to one of the second amplifiers 12a, 12b, . . . in the second amplifier group 12. Which second amplifier is to be selected by the switch 17 may be determined when manufacturing a circuit utilizing an integrated circuit including this audio signal processing circuit. This switch 17 can be mounted as a terminal (power output terminal) for outputting power supplied from the power supply unit 15 and a terminal group (power input terminal group) connected to power supply terminals of the second amplifiers 12a, 12b, . . . , respectively. In this case, the circuit designer connects one of the terminals of the power input terminal group to the power output terminal.

In this example, these power supply unit 15 and control unit 16 operate as a second selecting circuit, and the switch 17 operates as a selecting circuit. As this selecting circuit supplies power to one of the amplifying circuits (one of the second amplifiers 12) as a selection object, the one of the amplifying circuits is selectively caused to operate, and the amplifying circuit that is selectively caused to operate is caused to output an amplified audio signal.

The contents of the processing by the processing unit 14 will now be described. The processing unit 14 identifies whether the signal inputted from the expansion processing unit 13 is the stereo signal (L−R) or the second audio signal (SAP), in accordance with the control signal outputted from the control unit 16. Then, when the stereo signal is inputted, the processing unit 14 outputs a signal (L signal) acquired by adding the monaural signal to the stereo signal, as a left channel signal, and outputs a signal (R signal) acquired by subtracting the stereo signal from the monaural signal, as a right channel signal. When the second audio signal is inputted, the processing unit 14 outputs at least one of the monaural signal and the second audio signal, using one of the following three ways: (1) outputting the monaural signal to one channel and outputting the second audio signal to the other channel; (2) outputting the monaural signal to both of the left and right channels; and (3) outputting the second audio signal to both of the left and right channels.

Next, an exemplary design of a television apparatus using the audio signal processing circuit of this embodiment will be described. The designer of the television apparatus selects a second amplifier having an amplification factor which the designer considers optimum, from the second amplifiers 12a, 12b, . . . included in the second amplifier group 12. Then, the switch 17 is connected to enable supply of power to the selected second amplifier. The other terminals are connected in a manner similar to the conventional example.

The television apparatus using the audio signal processing circuit of this embodiment operates as follows. That is, the demodulating unit 1 demodulates an audio multiplexed signal and outputs the demodulated signal. The stereo signal demodulating unit 2 outputs a monaural signal and a stereo signal. The second audio signal filter 3 extracts a second audio signal from the audio multiplexed signal and outputs the extracted second audio signal.

When the user of the television apparatus has selected the stereo audio signal, a signal indicating that the stereo audio signal should be selected is inputted to the control unit 16 as a selection signal from the external control terminal (not shown) . In this case the control unit 16 outputs to the processing unit 14 and the power supply unit 15 a control signal indicating that power should be supplied to the first amplifier 11.

The power supply unit 15 supplies power to the first amplifier 11 and stops supplying power to the switch 17. The first amplifier 11 amplifies the stereo signal at a predetermined amplification factor and outputs the amplified stereo signal. Meanwhile, none of the second amplifiers 12a, 12b, . . . is supplied with power and these amplifiers do not output any signal. Therefore, the expansion processing unit 13 performs expansion processing on the signal outputted from the first amplifier 11 and outputs the expanded signal to the processing unit 14. The processing unit 14 identifies that the stereo signal is inputted on the basis of the control signal, and outputs a signal (L signal) acquired by mixing the monaural signal and the stereo signal, as a left channel signal, and a signal (Rsignal) acquired by subtracting the stereo signal from the monaural signal, as a right channel signal.

On the other hand, as the user of the television apparatus selects the second audio signal, a signal indicating that the second audio signal should be selected is inputted to the control unit 16 as a selection signal from the external control terminal (not shown) . In this case, the control unit 16 outputs to the processing unit 14 and the power supply unit 15 a control signal indicating that power should be supplied to the switch 17. In accordance with this control signal, the power supply unit 15 supplies power to the switch 17 and stops supplying power to the first amplifier 11. This causes power to be supplied to the second amplifier selected by the designer through the switch 17.

In short, power is not supplied to the first amplifier 11 or the second amplifiers that are not selected by the designer. No signal is outputted from the first amplifier 11 or the second amplifiers that are not selected by the designer. Accordingly, the expansion processing unit 13 performs expansion processing on the signal outputted from the second amplifier selected by the designer and outputs the expanded signal to the processing unit 14. Therefore, as a result of the expansion processing, the second audio signal amplified at the amplification factor intended by the designer is supplied to the processing unit 14.

The processing unit 14 identifies that the second audio signal is inputted on the basis of the control signal, and for example, it outputs the monaural signal to one channel (left channel, for example) and outputs the second audio signal to the other channel (right channel, for example).

In this manner, according to this embodiment, the amplification factor of an audio signal included in an audio multiplexed signal can be variably controlled in accordance with the designer's preference with a simple structure.

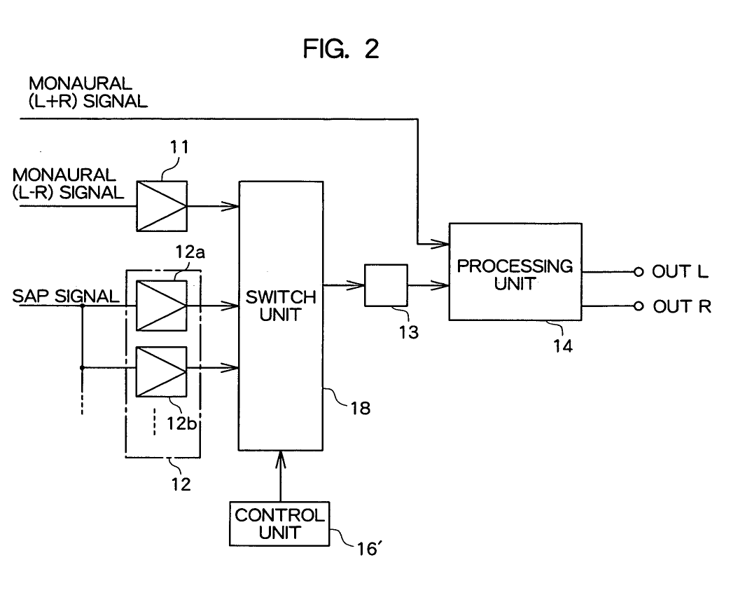

While the amplification factor of the second audio signal is variably controlled by controlling the state of power supply in the above description, one of the signals outputted from the individual amplifiers may be selectively taken out by the switch (FIG. 2).

In the example using the switch, the first amplifier 11 and the second amplifiers 12a, 12b, . . . are constantly supplied with power, and the first amplifier 11 amplifies the stereo signal and outputs the amplified stereo signal, while the second amplifiers 12a, 12b, . . . output the second audio signals amplified at different amplification factors from each other. A switch unit 18 selectively outputs one of the outputs of these amplifiers to the expansion processing unit 13 in accordance with a control signal inputted from a control unit 16′.

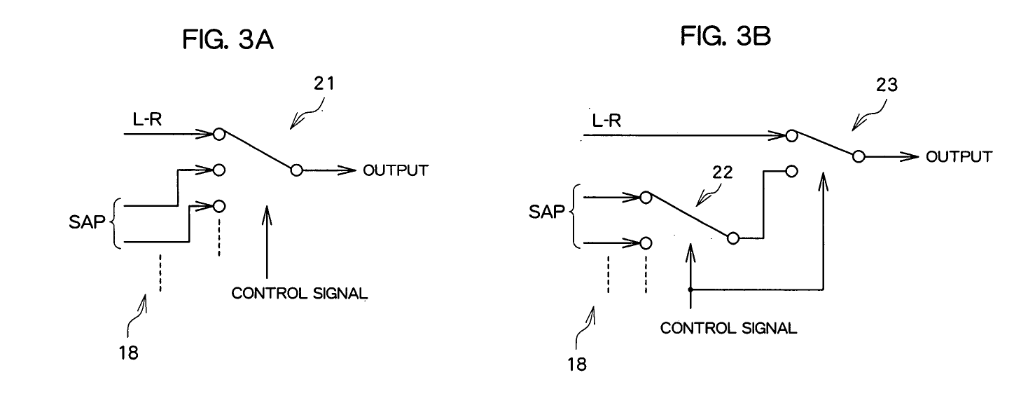

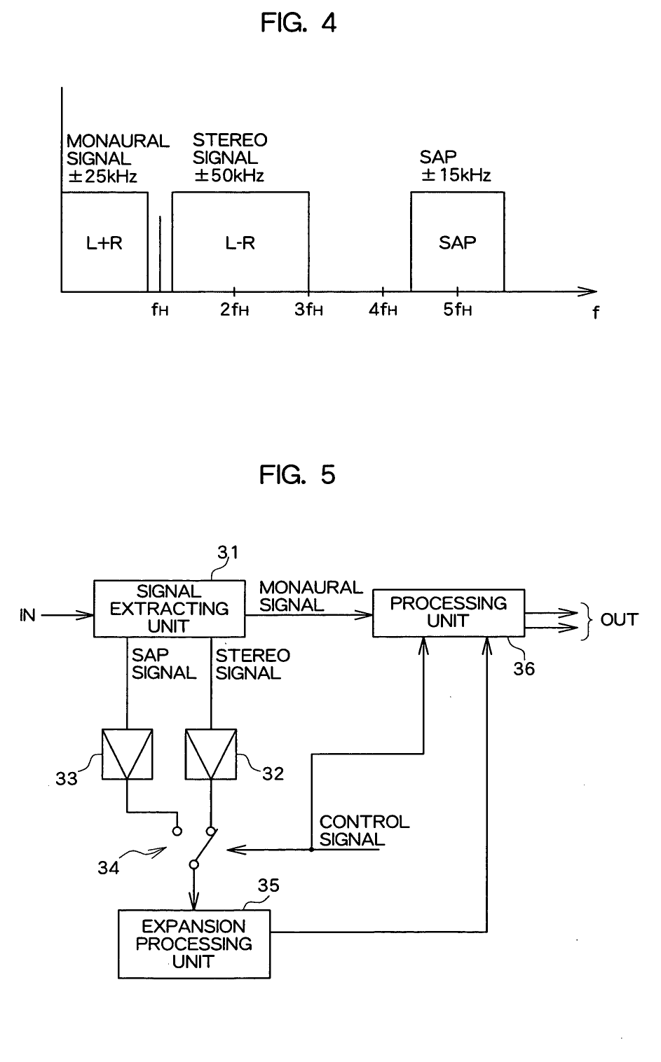

The switch unit 18 maybe constituted by a switch 21 for selecting one of the stereo signal (L-R) and the amplified second audio signals (SAP) outputted from the second amplifiers 12a, 12b, . . . , respectively, in accordance with the control signal, as shown in FIG. 3A. Alternatively, the switch unit 18 may be realized by using a first switch 22 for selecting one of the amplified second audio signals (SAP) outputted from the second amplifiers 12a, 12b, . . . , respectively, and a second switch 23 for selecting one of the signal outputted from the first switch and the stereo signal (L−R), as shown in FIG. 3B.

While the present invention is described in terms of preferred or exemplary embodiments, it is not limited hereto.

1. An audio signal processing circuit for demodulating an audio multiplexed signal and outputting the demodulated signal, comprising:
an extracting circuit for extracting a second audio signal from the audio multiplexed signal;
plural amplifying circuits for amplifying the second audio signal with different gains, respectively; and
a selecting circuit for selecting one of the plural amplifying circuits and selectively outputting an amplified audio signal outputted from the selected amplifying circuit.

2. The audio signal processing circuit as claimed in claim 1, wherein the selecting circuit supplies power to one of the amplifying circuits as a selection object, thereby selectively causing one of the amplifying circuits to operate and causing the amplifying circuit that is selectively caused to operate, to output an amplified audio signal.

3. The audio signal processing circuit as claimed in claim 1, further comprising:
a stereo signal amplifying circuit for extracting and amplifying a stereo signal from the audio multiplexed signal; and
a second selecting circuit for selectively outputting one of an audio signal outputted form the selecting circuit and an audio signal outputted from the stereo signal amplifying circuit.

4. An audio signal processing circuit for demodulating an audio multiplexed signal and outputting the demodulated signal, comprising:
an extracting circuit for extracting a second audio signal from the audio multiplexed signal;
a stereo signal amplifying circuit for extracting and amplifying a stereo signal from the audio multiplexed signal;
plural amplifying circuits for amplifying the second audio signal with different gains, respectively; and
a selecting circuit for selecting one of the plural amplifying circuits or the stereo signal amplifying circuit and selectively outputting an amplified audio signal outputted from the selected amplifying circuit or stereo signal amplifying circuit.

5. The audio signal processing circuit as claimed in claim 4, wherein the selecting circuit supplies power to one of the plural amplifying circuits and stereo signal amplifying circuit as a selection object, thereby selectively causing one of the amplifying circuits and stereo signal amplifying circuit to operate and causing the amplifying circuit or stereo signal amplifying circuit that is selectively caused to operate, to output an amplified audio signal.

6. The audio signal processing circuit as claimed in claim 4, wherein the stereo signal is a differential signal of a left channel signal and a right channel signal.

7. The audio signal processing circuit as claimed in claim 1, wherein the audio multiplexed signal is a BTSC audio multiplexed signal.
